(19) United States
(12) Patent Application Publication
(10) Pub. No.: US 2019/0094881 A1
(43) Pub. Date: Mar. 28, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Katsuaki Sasaki, Wako-shi (JP); Akihiro Toda, Wako-shi (JP); Yugo Ueda, Wako-shi (JP); Atsushi Arai, Tokyo (JP); Yuki Motegi, Tokyo (JP)

(21) Appl. No.: 16/135,253

(22) Filed: Sep. 19, 2018

(30) Foreign Application Priority Data
Sep. 22, 2017 (JP) 2017-182433

(51) Int. Cl. G05D 1/02

(52) U.S. Cl. CPC G05D 1/0276; B60W 10/04; G05D 1/0274; G05D 1/0221

(57) ABSTRACT

A vehicle control device includes an other-vehicle recognition unit that recognizes another vehicle stopped near a subject vehicle, a specific-vehicle determination unit that determines whether or not the other vehicle recognized by the other-vehicle recognition unit is a specific vehicle of which a main parking place is the place at which the other vehicle is stopped, and a driving control unit that controls one or both of steering and acceleration/deceleration of the subject vehicle to cause the subject vehicle to travel regardless of an operation of an occupant of the subject vehicle, the driving control unit suppressing, with respect to the other vehicle determined to be the specific vehicle by the specific-vehicle determination unit among the other vehicles recognized by the other-vehicle recognition unit, travel control of the subject vehicle with respect to start of the other vehicle as compared with the other vehicle not determined to be the specific vehicle by the specific-vehicle determination unit.

### CROSS-REFERENCE TO RELATED APPLICATION

Priority is claimed on Japanese Patent Application No. 2017-182433, filed Sep. 22, 2017, the content of which is incorporated herein by reference.

### FIELD OF THE INVENTION

The present invention relates to a vehicle control device, a vehicle control method, and a storage medium.

### DESCRIPTION OF RELATED ART

In recent years, research on automatic control of a vehicle has been performed. In relation thereto, a technology for detecting another vehicle in a route during automatic driving and performing predetermined control on a subject vehicle is known (see, for example, Japanese Unexamined Patent Application, First Publication No. 2017-35927).

However, the related art does not perform driving control of the subject vehicle by recognizing a relationship between a place at which the other vehicle is stopped and the other vehicle. Therefore, unnecessary driving control may be performed.

### SUMMARY OF THE INVENTION

The present invention has been made in consideration of such circumstances, and an object of the present invention is to provide a vehicle control device, a vehicle control method, and a storage medium capable of suppressing unnecessary driving control.

(1) A vehicle control device according to an aspect of the present invention is a vehicle control device including: an other-vehicle recognition unit that recognizes another vehicle stopped near a subject vehicle; a specific-vehicle determination unit that determines whether or not the other vehicle recognized by the other-vehicle recognition unit is a specific vehicle of which a main parking place is the place at which the other vehicle is stopped; and a driving control unit that controls one or both of steering and acceleration/deceleration of the subject vehicle to cause the subject vehicle to travel regardless of an operation of an occupant of the subject vehicle, the driving control unit suppressing, for the other vehicle determined to be the specific vehicle by the specific-vehicle determination unit among other vehicles recognized by the other-vehicle recognition unit, travel control of the subject vehicle with respect to start of the other vehicle as compared with a case in which the other vehicle is not determined to be the specific vehicle by the specific-vehicle determination unit.

(2) In the aspect of the vehicle control device described in (1), the specific-vehicle determination unit determines the other vehicle of which a main parking place is the place at which the other vehicle is stopped, the place at which the other vehicle is stopped being within a predetermined site, to be the specific vehicle.

(3) In the aspect of the vehicle control device described in (2), the specific-vehicle determination unit recognizes the predetermined site including a site of a parking spot at which parking is permitted according to a residence or a predetermined contract form.

(4) In the aspect of the vehicle control device described in (1), the vehicle control device further includes a storage unit that stores information, the other-vehicle recognition unit stores history information on a recognition result of another vehicle recognized in the past in the storage unit in association with a position of the subject vehicle, and the specific-vehicle determination unit determines whether or not the other vehicle is another vehicle parked within a predetermined site on the basis of whether the other vehicle recognized in the past at the same position as the position of the subject vehicle is the same as the other vehicle near the subject vehicle recognized by the other-vehicle recognition unit by referring to the history information stored in the storage unit using the position of the subject vehicle in case that the other vehicle near the subject vehicle is recognized by the other-vehicle recognition unit.

(5) In the aspect of the vehicle control device described in (2), in case that the specific-vehicle determination unit determines that the other vehicle is the specific vehicle parked at the predetermined site, the driving control unit suppresses an operation of deceleration control of the subject vehicle as compared with a case in which the other vehicle is determined not to be the other vehicle parked at the predetermined site.

(6) A vehicle control method according to an aspect of the present invention is a vehicle control method including: recognizing, by a computer mounted in a vehicle, another vehicle near a subject vehicle; determining, by the computer, whether or not the recognized other vehicle is another vehicle parked within a predetermined site; controlling, by the computer, one or both of steering and acceleration/deceleration of the subject vehicle to cause the subject vehicle to travel regardless of an operation of an occupant of the subject vehicle; and suppressing, by the computer, travel control of the subject vehicle with respect to start of the other vehicle in a case in which the other vehicle is determined to be the other vehicle parked at the predetermined site as compared with a case in which the other vehicle is determined not to be the other vehicle parked at the predetermined site.

(7) A storage medium according to an aspect of the present invention is a computer-readable non-transitory storage medium storing a program, the program causing a computer mounted in a vehicle to: recognize another vehicle near a subject vehicle and determine whether or not the recognized other vehicle is another vehicle parked within a predetermined site; control one or both of steering and acceleration/deceleration of the subject vehicle to cause the subject vehicle to travel regardless of an operation of an occupant of the subject vehicle; and suppress travel control of the subject vehicle with respect to start of the other vehicle in a case in which the other vehicle is determined to be the other vehicle parked at the predetermined site as compared with a case in which the other vehicle is determined not to be the other vehicle parked at the predetermined site.

According to the aspects (1), (6), and (7), it is possible to suppress unnecessary driving control of the subject vehicle.

According to the aspects (2), (3), and (4), it is possible to suppress unnecessary driving control such as execution of control such as temporary stop each time a stopped vehicle is recognized and prevent smooth traveling from being hindered, by determining the other vehicle of which the main parking place is within the predetermined site to be the specific vehicle.

According to the aspect (5), it is possible to perform driving control of an automatically driven vehicle according to the specific vehicle, and to suppress travel control such as excessive deceleration.

### BRIEF DESCRIPTION OF THE DRAWINGS

FIG. 1 is a configuration diagram of a vehicle system using a vehicle control device according to an embodiment.

FIG. 2 is a functional configuration diagram of a first control unit and a second control unit.

FIG. 3 is a diagram showing an example of another vehicle recognized by an other-vehicle recognition unit.

FIG. 4 is a diagram showing an example of content of other-vehicle recognition history information.

FIG. 5 is a flowchart showing an example of a flow of a process to be executed in an automatic driving control device.

FIG. 6 is a flowchart showing a flow of a process to be executed in step S120.

FIG. 7 is a flowchart showing a flow of a process to be executed in step S140.

FIG. 8 is a diagram showing a plurality of configurations that can be used in the automatic driving control device.

### DETAILED DESCRIPTION OF THE INVENTION

Hereinafter, an embodiment of a vehicle control device, a vehicle control method, and a storage medium according to the present invention will be described with reference to the drawings.

### [Overall Configuration]

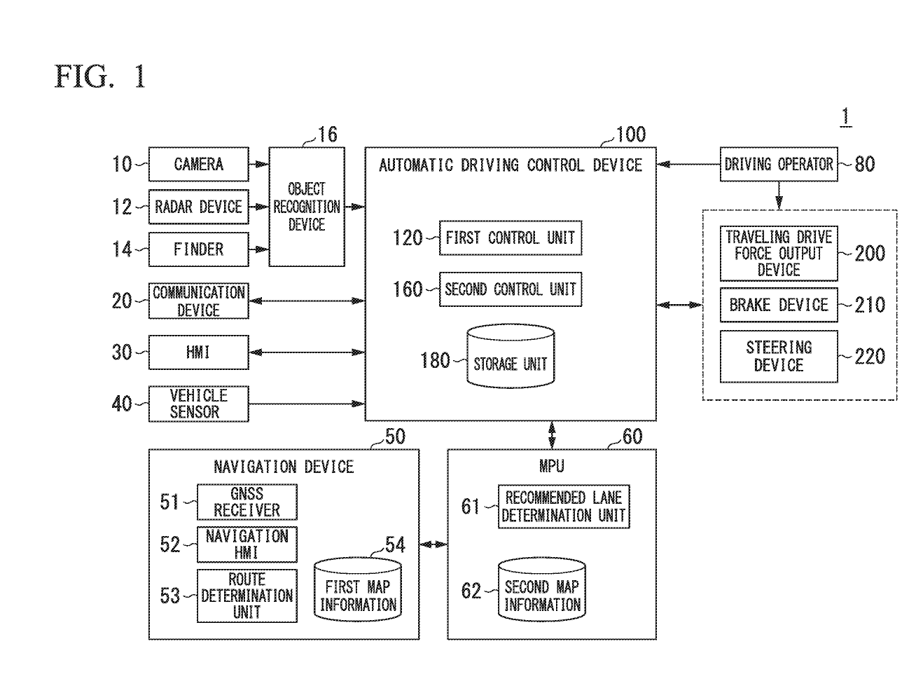

FIG. 1 is a configuration diagram of a vehicle system 1 using a vehicle control device according to an embodiment. A vehicle in which the vehicle system 1 is mounted is, for example, a vehicle such as a two-wheeled, three-wheeled, or four-wheeled vehicle. A driving source thereof is an internal combustion engine such as a diesel engine or a gasoline engine, an electric motor, or a combination thereof. In case that the electric motor is used, the electric motor is operated using power generated by a generator connected to an internal combustion engine, or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automatic driving control device 100 (an example of a vehicle control device), a travel driving force output device 200, a brake device 210, and a steering device 220. The apparatuses or devices are connected to each other by a multiplex communication line such as a controller area network (CAN) communication line, a serial communication line, a wireless communication network, or the like. It should be noted that the configuration illustrated in FIG. 1 is merely an example, and a part of the configuration may be omitted, or other configurations may be added.

The camera 10 is, for example, a digital camera using a solid-state imaging element such as a charge coupled device (CCD) or a complementary metal oxide semiconductor (CMOS). One or a plurality of cameras 10 are attached to any places on a vehicle in which the vehicle system 1 is mounted (hereinafter referred to as a subject vehicle M). In the case of forward imaging, the camera 10 is attached to an upper portion of a front windshield, a rear surface of a rearview mirror, or the like. The camera 10, for example, periodically repeatedly images the surroundings of the subject vehicle M. The camera 10 may be a stereo camera.

The radar device 12 radiates radio waves such as millimeter waves to the surroundings of the subject vehicle M and detects radio waves (reflected waves) reflected by an object to detect at least a position (distance and orientation) of the object. One or a plurality of radar devices 12 are attached to any places on the subject vehicle M. The radar device 12 may detect a position and a speed of an object using a frequency modulated continuous wave (FM-CW) scheme.

The finder 14 is a light detection and ranging (LIDAR). The finder 14 radiates light around the subject vehicle M and measures scattered light. The finder 14 detects a distance to a target on the basis of a time from light emission to light reception. The radiated light is, for example, pulsed laser light. One or a plurality of finders 14 are attached to any places on the subject vehicle M.

The object recognition device 16 performs a sensor fusion process on detection results of some or all of the camera 10, the radar device 12, and the finder 14 to recognize a position, type, speed, and the like of an object. The object recognition device 16 outputs recognition results to the automatic driving control device 100. The object recognition device 16 may output the detection results of the camera 10, the radar device 12, or the finder 14 to the automatic driving control device 100 as they are according to necessity.

The communication device 20, for example, communicates with another vehicle near the subject vehicle M using a cellular network, a Wi-Fi network, Bluetooth (registered trademark), dedicated short range communication (DSRC), or the like or communicates with various server devices via a wireless base station.

The HMI 30 presents various types of information to the occupant of the subject vehicle M and receives an input operation from an occupant. The HMI 30 includes various display devices, speakers, buzzers, a touch panel, switches, keys, and the like.

The vehicle sensor 40 includes, for example, a vehicle speed sensor that detects a speed of the subject vehicle M, an acceleration sensor that detects an acceleration, a yaw rate sensor that detects an angular speed around a vertical axis, and an orientation sensor that detects a direction of the subject vehicle M.

The navigation device 50 includes, for example, a global navigation satellite system (GNSS) receiver 51, a navigation HMI 52, and a route determination unit 53, and holds first map information 54 in a storage device such as a hard disk drive (HDD) or a flash memory. The GNSS receiver 51 specifies a position of the subject vehicle M on the basis of a signal received from a GNSS satellite. The position of the subject vehicle M may be specified or supplemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. The route determination unit 53, for example, determines a route (hereinafter, an on-map route) from the position of the subject vehicle M (or any input position) specified by the GNSS receiver 51 to a destination input by the occupant using the navigation HMI 52 by referring to the first map information 54. The first map information 54 is, for example, information in which a road shape is represented by links indicating roads and nodes connected by the links. The first map information 54 may include a curvature of the road, point of interest (POI) information, and the like. The on-map route determined by the route determination unit 53 is output to the MPU 60. The navigation device 50 may perform route guidance using the navigation HMI 52 on the basis of the on-map route determined by the route determination unit 53. It should be noted that the navigation device 50 may be realized, for example, by a function of a terminal device such as a smartphone or a tablet terminal possessed by an occupant. The navigation device 50 may transmit a current position and a destination to a navigation server via the communication device 20 and acquire the on-map route with which the navigation server replies.

The MPU 60, for example, functions as a recommended lane determination unit 61, and holds second map information 62 in a storage device such as an HDD or a flash memory. The recommended lane determination unit 61 divides the route provided from the navigation device 50 into a plurality of blocks (for example, divides the route every 100 [m] in a traveling direction of the vehicle), and determines a recommended lane for each block by referring to the second map information 62. The recommended lane determination unit 61 determines which of lanes from the left the subject vehicle M travels. The recommended lane determination unit 61 determines the recommended lane so that the subject vehicle M can travel on a reasonable route for traveling to a branch destination in case that there are branching points, merging points, or the like in the route.

The second map information 62 is map information with higher accuracy than the first map information 54. The second map information 62 includes, for example, information on a center of the lane or information on a boundary of the lane. The second map information 62 may include road information, traffic regulation information, address information (address and postal code), facility information, telephone number information, and the like. The second map information 62 may be updated at any time by accessing another device using the communication device 20.

The driving operator 80 includes, for example, an accelerator pedal, a brake pedal, a shift lever, a steering wheel, a modified steering wheel, a joystick, and other operators. A sensor that detects the amount of operation or the presence or absence of the operation is attached to the driving operator 80, and a result of the detection is output to one or both of the automatic driving control device 100 and one of the travel driving force output device 200, the brake device 210, and the steering device 220.

The automatic driving control device 100 includes, for example, a first control unit 120, a second control unit 160, and a storage unit 180. Each of the first control unit 120 and the second control unit 160 is realized, for example, by a hardware processor such as a central processing unit (CPU) executing a program (software). Some or all of such components may be realized by hardware (including circuitry) such as a large scale integration (LSI), an application specific integrated circuit (ASIC), or a field-programmable gate array (FPGA), or a graphics processing unit (GPU) or may be realized by software and hardware in cooperation. The program may be stored in a storage device (not illustrated) such as a hard disk drive (HDD) or a flash memory in advance, or the program may be stored in a detachable storage medium such as a DVD or a CD-ROM, the storage medium may be mounted on a drive device, and the program may be installed in the storage device.

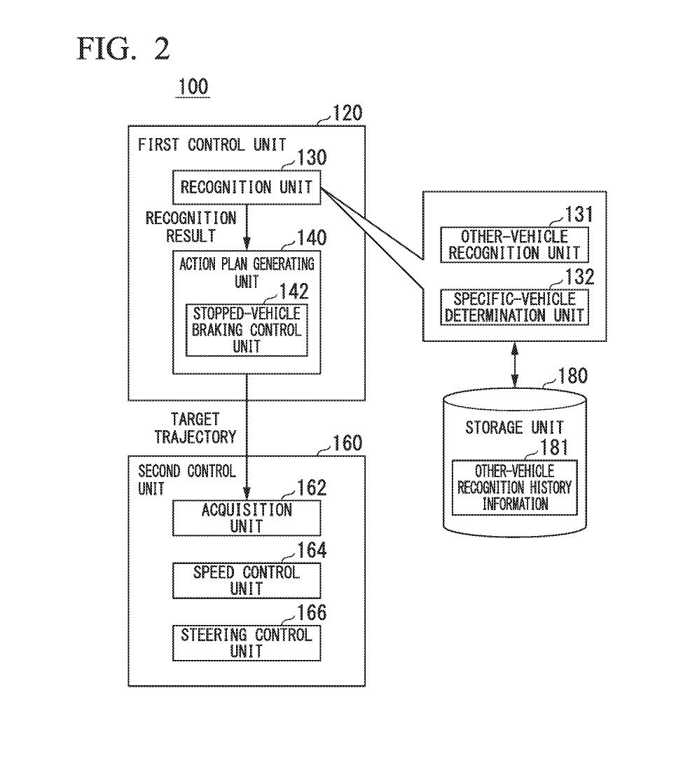

FIG. 2 is a functional configuration diagram of the first control unit 120 and the second control unit 160. The first control unit 120 includes, for example, a recognition unit 130 and an action plan generation unit 140. A function of a stopped-vehicle braking control unit 142 of the action plan generation unit 140 will be described below.

The first control unit 120 realizes, for example, a function based on artificial intelligence (AI) and a function based on a previously given model in parallel. For example, in a function of “recognizing an intersection,” recognition of an intersection using deep learning or the like and recognition based on previously given conditions (a signal which can be subjected to pattern matching, a road sign, or the) are executed in parallel, and the function is realized by scoring both recognitions and comprehensively evaluating the recognitions. Accordingly, the reliability of automatic driving is guaranteed.

The recognition unit 130 recognizes a position and a state such as a speed or an acceleration of an object near the subject vehicle M on the basis of information input from the camera 10, the radar device 12, and the finder 14 via the object recognition device 16. The object is, for example, a moving body such as another vehicle or a pedestrian. The position of the object is recognized, for example, as a position based on absolute coordinates with a representative point (for example, a centroid or a driving axis center) of the subject vehicle M as an origin, and is used for control. The position of the object may be represented by a representative point such as a centroid or a corner of the object or may be represented by a represented area. The “state” of the object may include an acceleration or jerk of the object, or an “action state” (for example, whether or not the object is changing lanes or is about to change lanes). The recognition unit 130 recognizes a shape of a curve that the subject vehicle M is about to pass on the basis of a captured image of the camera 10. It should be noted that the recognition unit 130 converts the shape of the curve from the captured image of the camera 10 to a real plane and outputs, for example, two-dimensional point sequence information or information represented by using a model equivalent thereto to the action plan generation unit 140 as information indicating the shape of the curve.

The recognition unit 130 recognizes, for example, a lane (traveling lane) on which the subject vehicle M is traveling. For example, the recognition unit 130 compares a pattern of a road marking line (for example, an arrangement of a solid line and a broken line) obtained from the second map information 62 with a pattern of a road marking line near the subject vehicle M recognized from the image captured by the camera 10 to recognize the traveling lane. It should be noted that the recognition unit 130 may recognize not only the road marking line but also a traveling road boundary (road boundary) including the road marking line, a road shoulder, a curb, a median strip, a guard rail, or the like to recognize the traveling lane. In this recognition, the position of the subject vehicle M acquired from the navigation device 50 or a processing result of an INS may be added. The recognition unit 130 recognizes a temporary stop line, an obstacle, a red light, a toll gate, a parking place of another vehicle, and other road events.

The recognition unit 130 recognizes a position or a posture of the subject vehicle M relative to the traveling lane in case that recognizing the traveling lane. The recognition unit 130 may recognize, for example, a deviation of a reference point of the subject vehicle M from a center of the lane, and an angle formed with respect to a line connecting a center of a lane in a traveling direction of the subject vehicle M as a relative position and a posture of the subject vehicle M with respect to the traveling lane. Instead, the recognition unit 130 may recognize, for example, a position of the reference point of the subject vehicle M with respect to any one of side end portions (the road marking line or the road boundary) of the traveling lane as the relative position of the subject vehicle M with respect to the traveling lane.

The recognition unit 130 may derive recognition accuracy in the above recognition process and output recognition accuracy as the recognition accuracy information to the action plan generation unit 140. For example, the recognition unit 130 generates the recognition accuracy information on the basis of a frequency of recognition of the road marking lines in a certain period.

Functions of the other-vehicle recognition unit 131 and the specific-vehicle determination unit 132 included in the recognition unit 130 will be described below.

The action plan generation unit 140 generates a target trajectory along which the subject vehicle M will travel in the future so that the subject vehicle M travels in the recommended lane determined by the recommended lane determination unit 61 in principle and automatic driving corresponding to a surrounding situation of the subject vehicle M is executed. The target trajectory includes, for example, a speed element. For example, the target trajectory is represented as a sequence of points (trajectory points) to be reached by the subject vehicle M.

The second control unit 160 includes, for example, an acquisition unit 162, a speed control unit 164, and a steering control unit 166. The acquisition unit 162 acquires information on the target trajectory (track points) generated by the action plan generation unit 140 and stores the information on the target trajectory in a memory (not illustrated). The speed control unit 164 controls the travel driving force output device 200 or the brake device 210 on the basis of the speed element included in the target trajectory stored in the memory. The steering control unit 166 controls the steering device 220 according to a degree of bend of the target trajectory stored in the memory. Processes of the speed control unit 164 and the steering control unit 166 are realized by, for example, a combination of feedforward control and feedback control. For example, the steering control unit 166 executes a combination of feedforward control according to a curvature of a road in front of the subject vehicle M and feedback control based on a deviation from the target trajectory.

It should be noted that in the automatic driving control device 100, a combination of the action plan generation unit 140, the acquisition unit 162, the speed control unit 164, and the steering control unit 166 is an example of a “driving control unit.”

The travel driving force output device 200 outputs a travel driving force (torque) for traveling of the subject vehicle M to the driving wheels. The travel driving force output device 200 includes, for example, a combination with an internal combustion engine, an electric motor, a transmission, and the like, and an ECU that controls these. The ECU controls the above configuration according to information input from the second control unit 160 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the second control unit 160 or information input from the driving operator 80 so that a brake torque in response to a braking operation is output to each wheel. The brake device 210 may include a mechanism that transfers the hydraulic pressure generated by the operation of the brake pedal included in the driving operator 80 to the cylinder via a master cylinder as a backup. It should be noted that the brake device 210 is not limited to the configuration described above and may be an electronically controlled hydraulic brake device that controls the actuator according to information input from the second control unit 160 and transfers the hydraulic pressure of the master cylinder to the cylinder.

The steering device 220 includes, for example, a steering ECU and an electric motor. The electric motor, for example, changes a direction of the steerable wheels by causing a force to act on a rack and pinion mechanism. The steering ECU drives the electric motor according to information input from the second control unit 160 or information input from the driving operator 80 to change the direction of the steerable wheels.

### [Determination of Specific Vehicle]

Next, the content of a process recognized by the recognition unit 130 will be described.

The recognition unit 130 includes, for example, an other-vehicle recognition unit 131 and a specific-vehicle determination unit 132. The other-vehicle recognition unit 131 stores information in the storage unit 180, and the specific-vehicle determination unit 132 reads information from the storage unit 180. The storage unit 180 holds, for example, other-vehicle recognition history information 181 in a storage device such as an HDD or a flash memory. The other-vehicle recognition unit 131 stores, for example, the other-vehicle recognition history information 181 which is a recognition result of another vehicle m recognized in the past in the storage unit 180 in association with the position of the subject vehicle M. The action plan generation unit 140 includes, for example, the stopped-vehicle braking control unit 142.

The other-vehicle recognition unit 131 recognizes, for example, another vehicle stopped near the subject vehicle M on the basis of the recognition result of the object recognition device 16 in a traveling route of the subject vehicle M.

The specific-vehicle determination unit 132 determines whether or not the other vehicle m recognized by the other-vehicle recognition unit 131 is a specific vehicle of which a main parking place is a place at which the vehicle is stopped on the basis of the recognition result of the other-vehicle recognition unit 131. The stopped-vehicle braking control unit 142 performs travel control of the subject vehicle M on the basis of a determination result of the specific-vehicle determination unit 132. A more specific process will be described below.

First, a process to be executed in the other-vehicle recognition unit 131 will be described.

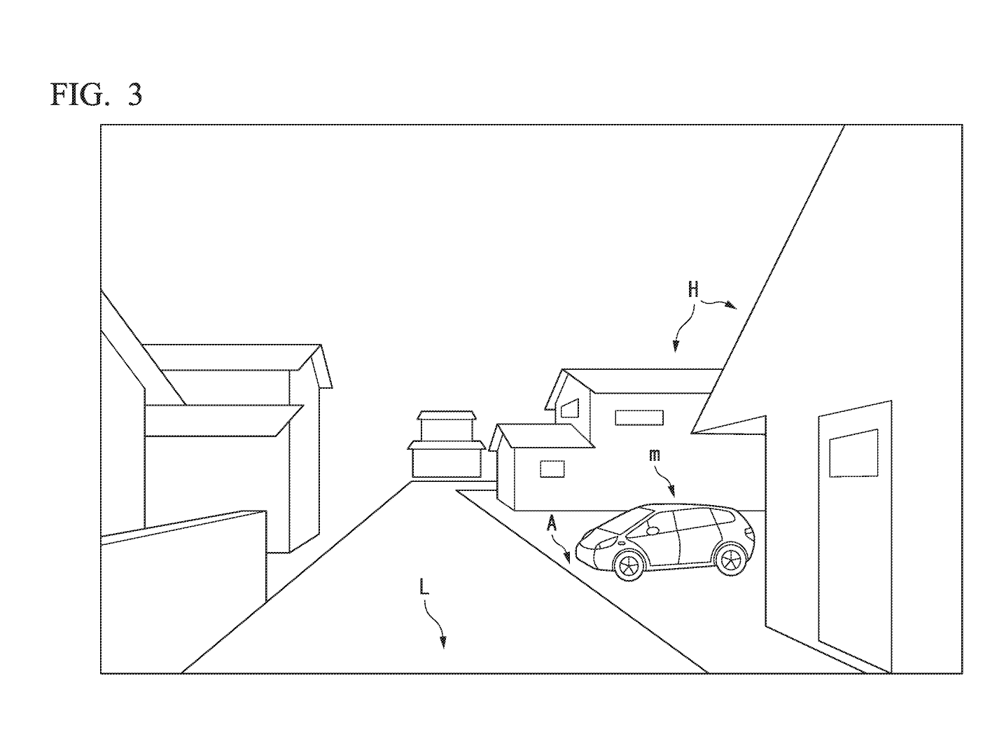

FIG. 3 is a diagram showing an example of the other vehicle m to be recognized by the other-vehicle recognition unit 131. Although the case in which the other vehicle m is stopped in a direction orthogonal to the subject vehicle M is illustrated, the other vehicle m may be parked in parallel to the subject vehicle M. The other-vehicle recognition unit 131 recognizes, for example, the stopped vehicle as another vehicle m that is a target that provides information to the stopped-vehicle braking control unit 142.

The other-vehicle recognition unit 131 reads, for example, matters (for example, a vehicle identification number) described on a license plate of the recognized other vehicle m on the basis of the image acquired from the object recognition device 16 and specifies the other vehicle m. Further, the other-vehicle recognition unit 131 may perform pattern matching on the basis of the captured image and specify the other vehicle m. The other-vehicle recognition unit 131 may recognize, as the other vehicle m, a vehicle parked in a state in which most of a vehicle body is placed at a parking place A which is not a road or may also recognize a vehicle stopped at an alley or the like as the other vehicle m.

The other-vehicle recognition unit 131 stores information on the recognized other vehicle m in the storage unit 180 in association with a position. The information on the recognized other vehicle m is, for example, matters described on a license plate of the other vehicle m or matching information such as a shape, a color, and a size of the other vehicle m subjected to pattern matching.

Further, the other-vehicle recognition unit 131 determines whether or not the position at which the other recognized vehicle m is stopped (hereinafter, a stop position) is a predetermined site facing the road. The predetermined site is, for example, a parking place (A in FIG. 3) secured within a site of a residence at which there is a house H or the like. In addition, the predetermined site may include a site such as a month-to-month parking at which parking is permitted according to a predetermined contract form, or a coin operated parking spot.

The other-vehicle recognition unit 131, for example, determines whether or not the stop position is a predetermined site on the basis of some or all of the position of the subject vehicle M specified by the navigation device 50, the site information stored in the second map information 62, and the other-vehicle recognition history information 181.

The site information is information in which information (site type information) on a type of site such as a residence, a month-to-month parking, a coin operated parking spot, or a shop is stored in association with an address (position). The site information is, for example, a partial database constituting a part of the second map information 62 including a set of points of interest (POI).

In case that the other-vehicle recognition unit 131 determines whether or not the stop position is the predetermined site on the basis of the position of the subject vehicle M and the second map information 62, the other-vehicle recognition unit 131 acquires site type information indicated in a record of site information on a site which is within a predetermined distance from the position of the subject vehicle M as the site type information of the stop position of the other vehicle m.

In case that the other-vehicle recognition unit 131 determines whether or not the stop position of the other vehicle m is the predetermined site on the basis of the other-vehicle recognition history information 181, the site information is acquired through matching with recognition information of the other vehicle m since the other-vehicle recognition history information 181 includes the site information as will be described below.

In case that the other-vehicle recognition unit 131 determines whether or not the stop position of the other vehicle m is the predetermined site on the basis of the position of the subject vehicle M and the other-vehicle recognition history information 181, the other-vehicle recognition unit 131 acquires the site type information indicated in the record of the other-vehicle recognition history information 181 on the other vehicle which is within a predetermined distance from the position of the subject vehicle M as the site type information of the stop position of the other vehicle m since the other-vehicle recognition history information 181 includes the other-vehicle position as will be described below. The record refers to information associated with one piece of identification information or the like in a database.

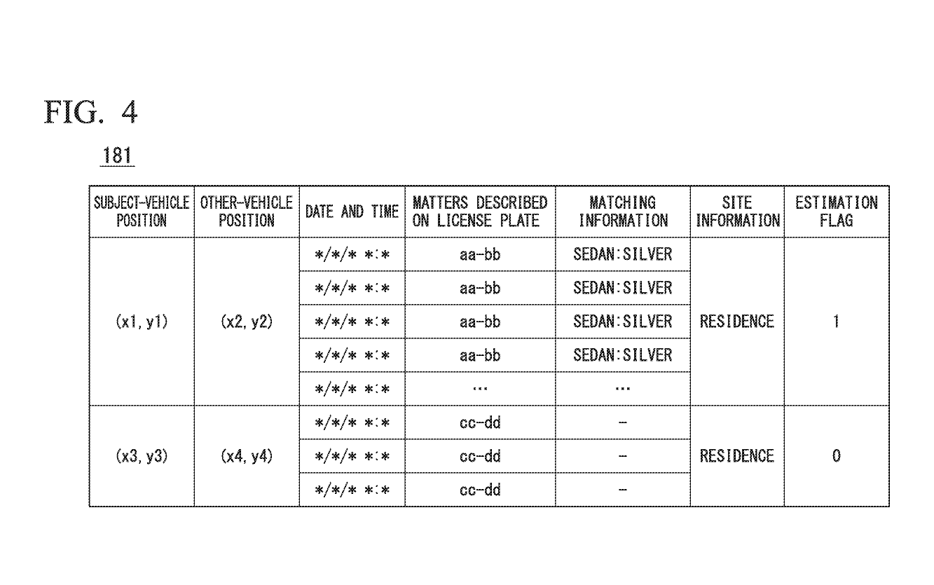

Hereinafter, the other-vehicle recognition history information 181 will be described. FIG. 4 is a diagram showing an example of the content of the other-vehicle recognition history information 181. The other-vehicle recognition unit 131 stores some or all of a position of the subject vehicle M, a date and time, a position of the other vehicle m, license plate descriptions of the other vehicle m, matching information, site information, estimation flag, and the like in case that the other vehicle m is recognized during traveling, in the storage unit 180 as the other-vehicle recognition history information 181.

In the other-vehicle recognition history information 181, the subject-vehicle position and the other-vehicle position may be areas that allow some variation. For example, the other-vehicle recognition unit 131 compares an image of the other vehicle m captured by the camera 10 at a certain point in time with an image of the other vehicle m captured after the subject vehicle travels a predetermined distance, and calculates a relative position of the other vehicle m from the position of the subject vehicle M on the basis of a change in the image of the other vehicle m to calculate the position of the other vehicle m. In the other-vehicle recognition history information 181, the matching information includes a shape, color, and other information of the other vehicle m.

The other-vehicle recognition unit 131 causes information on the other vehicle m recognized each time the subject vehicle M travels on the route to be stored in the storage unit 180 in association with, for example, the position of the subject vehicle M and accumulates information on the other vehicle m.

For example, in case that a sufficient number of pieces of information are accumulated for a record of certain other-vehicle recognition history information 181, the other-vehicle recognition unit 131 assigns an estimation flag to the record.

The estimation flag is, for example, information indicating that the vehicle is a vehicle of which a main parking place is a place at which the vehicle is stopped. The other-vehicle recognition unit 131 determines, for example, whether or not the parking place of the other vehicle m is a predetermined site on the basis of the accumulated other-vehicle recognition history information 181. In case that the other-vehicle recognition unit 131 determines that the parking place of the other vehicle m is the predetermined site, the other-vehicle recognition unit 131 determines whether or not a frequency at which the same other vehicle m is parked at the predetermined site is high.

In case that the other-vehicle recognition unit 131 determines that the frequency at which the same other vehicle m is parked at the predetermined site is high, the other-vehicle recognition unit 131 estimates the other vehicle m to be a specific vehicle and generates information of the estimation flag. The specific vehicle is another vehicle m of which the stop place is a main parking place and the stop place is within the predetermined site.

For example, in case that a sufficient number (for example, five or more) of pieces of information to perform estimation of the estimation flag with respect to the other vehicle m are accumulated, the other-vehicle recognition unit 131 estimates the recognized other vehicle m to be the specific vehicle on the basis of the site information stored in the second map information 62 and the other-vehicle recognition history information 181, changes the estimation flag from “0” to “1”, and assigns information to the other-vehicle recognition history information 181.

For example, in case that the other-vehicle recognition unit 131 determines that the stop position is a predetermined site such as a “house” or a “month-to-month parking” that the other vehicle m enters and exits at a low frequency on the basis of the site information, the other-vehicle recognition unit 131 sets a likelihood of the other vehicle m being estimated to be the specific vehicle to be higher than that of a site such as a coin operated parking spot or a shop where the other vehicle m enters and exits at a high frequency.

In addition, the other-vehicle recognition unit 131 may generate the estimation flag according to a time period, a day of a week, and a period by referring to a calendar. For example, in case that the subject vehicle M is traveling in a predetermined time period of a holiday, the other-vehicle recognition unit 131 changes the estimation flag from “1” to “0” for the other vehicle m parked at the house H. This is because the other vehicle m parked at the house H in the predetermined time period of the holiday is recognized to have more opportunities to enter and exit the parking place A as compared with a weekday.

Similarly, the other-vehicle recognition unit 131 may change the estimation flag according to the time period, the day of the week, and the period on the basis of the site information even in case that the other vehicle m is stopped at the same stop position. For example, in case that the site type is a “company” in the site information, the other-vehicle recognition unit 131 may change the estimation flag according to a holiday and a business day.

Next, a process to be executed in the specific-vehicle determination unit 132 will be described.

For example, in case that the other vehicle m near the subject vehicle M is recognized by the other-vehicle recognition unit 131, the specific-vehicle determination unit 132 acquires past information of the other vehicle m associated with the position of the subject vehicle M stored in the storage unit 180 by referring to the other-vehicle recognition history information 181 stored in the storage unit 180.

The specific-vehicle determination unit 132 determines whether or not the other vehicle m currently recognized at the same position by the subject vehicle M is the same as the other vehicle m recognized in the past on the basis of the other-vehicle recognition history information 181 stored in the storage unit 180.

In case that the specific-vehicle determination unit 132 determines that the other vehicle m recognized currently is the same as the other vehicle m recognized in the past, the specific-vehicle determination unit 132 determines a type of site at which the other vehicle m is parked by referring to the other-vehicle recognition history information 181 stored in the storage unit 180.

In case that the specific-vehicle determination unit 132 determines the type of site at which the other vehicle m is parked, the specific-vehicle determination unit 132 determines whether or not the other vehicle m is another vehicle m parked within a predetermined site on the basis of the type of site at which the other vehicle m is parked. Through such a process, the specific-vehicle determination unit 132 can determine whether a vehicle is stopped outside a predetermined site or whether a vehicle is parked within the site.

This is because, for example, another vehicle m that is stopped on a road in front of the house H may not be a parked vehicle but may start and a vehicle parked at a coin operated parking spot or the like frequently enters and exits as compared with a predetermined site, and therefore, travel control of the subject vehicle M is required as will be described below according to the above determination.

In case that the specific-vehicle determination unit 132 determines that a place at which the other vehicle m is parking is the predetermined site on the basis of the position information of the other vehicle m and the information on the site, the specific-vehicle determination unit 132 determines the recognized other vehicle m is another vehicle m parked within the predetermined site.

Then, the specific-vehicle determination unit 132 determines whether or not the other vehicle m parked within the predetermined site is the specific vehicle on the basis of the information of the estimation flag by referring to the other-vehicle recognition history information 181 stored in the storage unit 180. The specific-vehicle determination unit 132 outputs a result of the determination as to whether the other vehicle is the specific vehicle to the stopped-vehicle braking control unit 142.

Next, a process that is executed in the stopped-vehicle braking control unit 142 will be described.

In case that the specific-vehicle determination unit 132 determines that the other vehicle m is the specific vehicle parked at the predetermined site, the stopped-vehicle braking control unit 142 performs control to be described below.

(1) In case that the specific-vehicle determination unit 132 determines that the other vehicle m is not the specific vehicle parked at the predetermined site, the stopped-vehicle braking control unit 142 controls the speed control unit 164 and the steering control unit 166 and performs predetermined deceleration control of the subject vehicle M. The predetermined deceleration control is, for example, controlling the speed control unit 164 and the steering control unit 166 to cause the subject vehicle M to perform an operation including deceleration, crawling, detouring, temporary stop, and the like. The predetermined deceleration control also includes a control for prohibiting acceleration.

(2) In case that the specific-vehicle determination unit 132 determines that the other vehicle m is the specific vehicle parked at the predetermined site, the stopped-vehicle braking control unit 142 controls the speed control unit 164 and the steering control unit 166 to control so that an operation of the deceleration control of the subject vehicle M is suppressed as compared with a case in which the other vehicle m is determined not to be the other vehicle parked at the predetermined site. The control for suppressing the operation of the deceleration control of the subject vehicle M refers to, for example, control for causing the subject vehicle M to travel without the stopped-vehicle braking control unit 142 performing predetermined deceleration control, reducing a degree of the deceleration control as compared with the deceleration control for the non-specific vehicle, or releasing acceleration prohibition even in case that the other vehicle m is located within a predetermined distance range with respect to the subject vehicle M.

For example, since the specific vehicle is parked at the parking place A within the predetermined site such as the house H in a time period in which the subject vehicle M travels, it is recognized that there are few opportunities to enter and exit the parking place A as compared with a parking place such as a coin operated parking spot or a shop. Therefore, in case that the other vehicle m is determined to be the specific vehicle, predetermined deceleration control is prevented from being excessively performed by the stopped-vehicle braking control unit 142.

### [Process Flow]

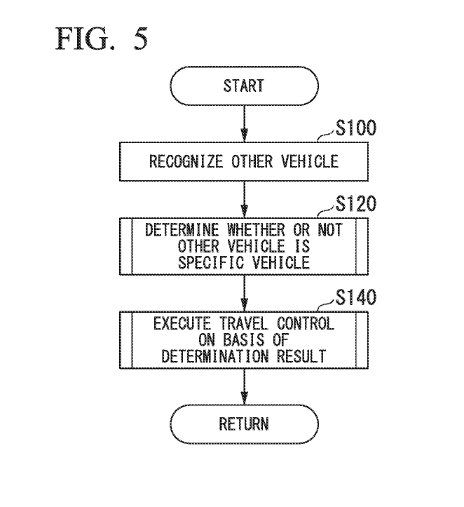

Next, a flow of a process to be executed in the automatic driving control device 100 will be described. FIG. 5 is a flowchart showing an example of a flow of a process to be executed in the automatic driving control device 100.

The other-vehicle recognition unit 131 recognizes the other vehicle m which is stopped near the subject vehicle M on the basis of the recognition result of the object recognition device 16 (step S100). The specific-vehicle determination unit 132 determines whether or not the other vehicle m recognized by the other-vehicle recognition unit 131 is a specific vehicle of which a main parking place is a place at which the vehicle is stopped (step S120).

The stopped-vehicle braking control unit 142 controls the speed control unit 164 and the steering control unit 166 on the basis of a determination result of the specific-vehicle determination unit 132 to perform predetermined deceleration control of the subject vehicle M (step S140).

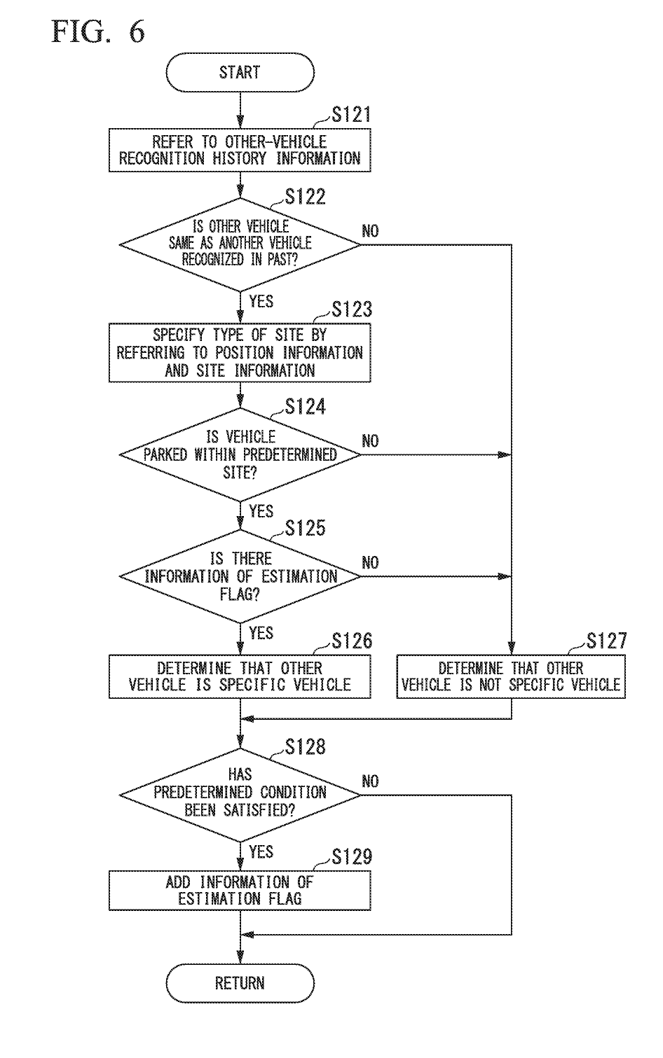

Next, the process of determining whether or not the other vehicle m is the specific vehicle, which is executed in step S120, will be described in detail. FIG. 6 is a flowchart showing the flow of the process executed in step S120.

For example, in case that the other vehicle m near the subject vehicle M is recognized by the other-vehicle recognition unit 131, the specific-vehicle determination unit 132 acquires information on the other vehicle m associated with the position of the subject vehicle M by referring to the other-vehicle recognition history information 181 stored in the storage unit 180 (step S121).

The specific-vehicle determination unit 132 determines whether or not the other vehicle m near the subject vehicle M currently recognized by the other-vehicle recognition unit 131 is the same as the other vehicle m recognized in the past at the same position as the position of the subject vehicle M on the basis of the other-vehicle recognition history information 181 stored in the storage unit 180 (step S122).

In case that the specific-vehicle determination unit 132 determines that the other vehicle m recognized currently is the same as the other vehicle m recognized in the past at the same position as the position of the subject vehicle M, the specific-vehicle determination unit 132 acquires the position information of the other vehicle m by referring to the other-vehicle recognition history information 181 stored in the storage unit 180, and specifies a type of a site that is a parking position of the other vehicle m by referring to the site information stored in the second map information 62 on the basis of the position information of the other vehicle m (step S123).

The specific-vehicle determination unit 132 determines whether or not the other vehicle m is another vehicle m parked within the predetermined site on the basis of the type of site at which the other vehicle m is parked (step S124). In case that the specific-vehicle determination unit 132 determines that the other vehicle m is the other vehicle m parked within the predetermined site, the specific-vehicle determination unit 132 determines whether or not there is information of the estimation flag in the other vehicle m by referring to the other-vehicle recognition history information 181 stored in the storage unit 180 (step S125). In case that there is information of the estimation flag, the specific-vehicle determination unit 132 determines that the other vehicle m is the specific vehicle (step S126).

In case that the specific-vehicle determination unit 132 determines that the other vehicle m recognized currently is not the same as the other vehicle m recognized in the past at the same position as the position of the subject vehicle M in step 122, the specific-vehicle determination unit 132 determines that the other vehicle m is not the specific vehicle (step S127). In case that the specific-vehicle determination unit 132 determines in step 124 that the other vehicle m is not the other vehicle m parked within the predetermined site, the specific-vehicle determination unit 132 determines that the other vehicle m is not the specific vehicle (step S127). In case that there is no information of the estimation flag in step 125, the specific-vehicle determination unit 132 determines that the other vehicle m is not the specific vehicle (step S127).

After the process of step 126 or step 127, the other-vehicle recognition unit 131 determines whether or not a predetermined condition such as accumulation of a sufficient number of pieces of information for a record of the other-vehicle recognition history information 181 is satisfied (step S128). In case that the other-vehicle recognition unit 131 determines that the predetermined condition is satisfied, the other-vehicle recognition unit 131 generates the information of the estimation flag on the basis of the other-vehicle recognition history information 181, adds the information to the other-vehicle recognition history information 181, and ends the process of the flowchart (step S129). In case that the other-vehicle recognition unit 131 determines that the predetermined condition is not satisfied, the other-vehicle recognition unit 131 ends the process of the flowchart. In the above flowchart, since the comparison with the past history is performed in steps S121 and S122, the processes of steps S125, S128, and S129, for example, may be omitted.

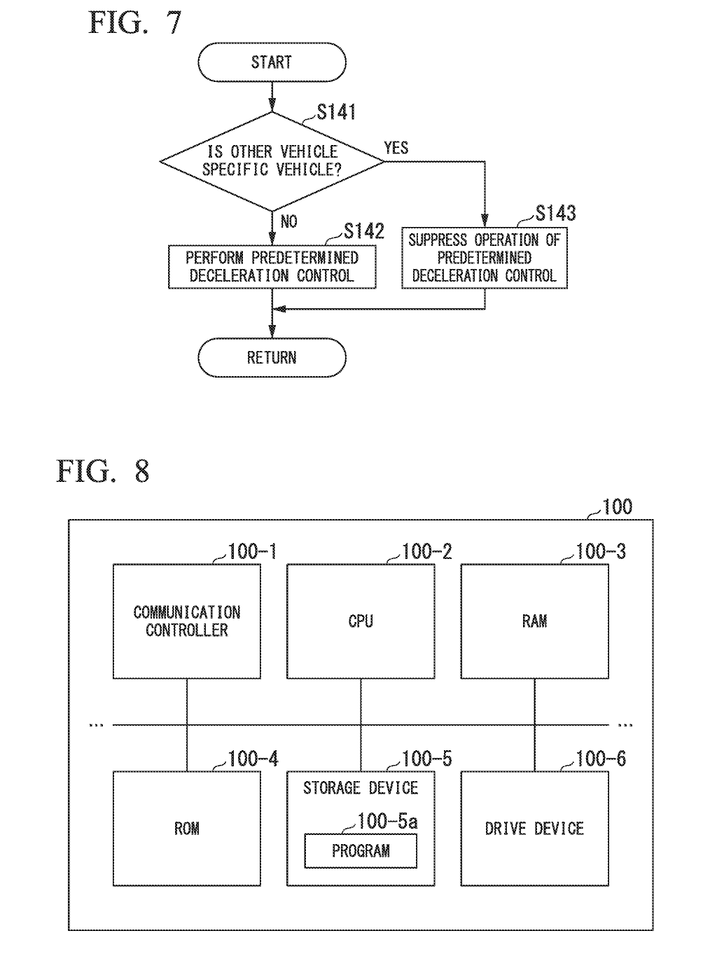

Next, the process regarding travel control of the subject vehicle M executed in step S140 will be described in detail. FIG. 7 is a flowchart showing the flow of the process executed in step S140.

The stopped-vehicle braking control unit 142 determines whether or not the other vehicle m is the specific vehicle on the basis of the determination result of the specific-vehicle determination unit 132 (step S141). In case that the other vehicle m is determined not to be the specific vehicle, the stopped-vehicle braking control unit 142 controls the speed control unit 164 and the steering control unit 166 to perform predetermined deceleration control of the subject vehicle M (step S142).

In case that the other vehicle m is determined to be the specific vehicle, the stopped-vehicle braking control unit 142 controls the speed control unit 164 and the steering control unit 166 so that the operation of the deceleration control of the subject vehicle M is suppressed as compared with the case in which the other vehicle m is determined not to be the other vehicle parked at the predetermined site (step S143).

According to the above-described embodiment, the vehicle system 1 can prevent control such as temporary stop or deceleration from being excessively performed in case that the other vehicle m is recognized during automatic driving, and realize smooth traveling according to automatic driving.

The above-described embodiment can be represented as follows. FIG. 8 is a diagram showing a plurality of configurations that can be used in the automatic driving control device 100. The automatic driving control device 100 includes, for example, a communication controller 100-1, a CPU 100-2, a RAM 100-3 used as a working memory, a ROM 100-4 that stores a boot program or the like, a storage device 100-5 such as a flash memory and an HDD, and a drive device 100-6, which are connected to each other via an internal bus or a dedicated communication line.

The communication controller 100-1 performs communication with a component other than the automatic driving control device 100 illustrated in FIG. 1. A program 100-5a to be executed by the CPU 100-2 is stored in the storage device 100-5. This program is developed in the RAM 100-3 by a direct memory access (DMA) controller (not illustrated) or the like and executed by the CPU 100-2. Accordingly, some or all of the recognition unit 130, the action plan generation unit 140, the acquisition unit 162, the speed control unit 164, and the steering control unit 166 are realized.

The above-described embodiment can be represented as follows.

The vehicle control device includes

a storage device, and

a hardware processor that executes a program stored in a storage device,

wherein the hardware processor is configured to

recognize another vehicle stopped near a subject vehicle,

determine whether or not the recognized other vehicle is another vehicle parked within a predetermined site by a specific-vehicle determination unit,

control one or both of steering and acceleration/deceleration of the subject vehicle to cause the subject vehicle to travel regardless of an operation of an occupant of the subject vehicle, and

suppress travel control of the subject vehicle with respect to start of the other vehicle in a case in which the other vehicle is determined to be the other vehicle parked at the predetermined site as compared with a case in which the other vehicle is determined not to be the other vehicle parked at the predetermined site, by executing the program.

Although a mode for carrying out the present invention has been described above using the embodiment, the present invention is not limited to the embodiment at all, and various modifications and substitutions may be made without departing from the spirit of the present invention.

What is claimed is:

1. A vehicle control device comprising:
an other-vehicle recognition unit that recognizes another vehicle stopped near a subject vehicle;
a specific-vehicle determination unit that determines whether or not the other vehicle recognized by the other-vehicle recognition unit is a specific vehicle of which a main parking place is the place at which the other vehicle is stopped; and
a driving control unit that controls one or both of steering and acceleration/deceleration of the subject vehicle to cause the subject vehicle to travel regardless of an operation of an occupant of the subject vehicle, the driving control unit suppressing, with respect to the other vehicle determined to be the specific vehicle by the specific-vehicle determination unit among other vehicles recognized by the other-vehicle recognition unit, travel control of the subject vehicle with respect to start of the other vehicle as compared with the other vehicle not determined to be the specific vehicle by the specific-vehicle determination unit.

2. The vehicle control device according to claim 1, wherein the specific-vehicle determination unit determines the other vehicle of which a main parking place is the place at which the other vehicle is stopped, the place at which the other vehicle is stopped being within a predetermined site, to be the specific vehicle.

3. The vehicle control device according to claim 2, wherein the specific-vehicle determination unit recognizes the predetermined site including a site of a parking spot at which parking is permitted according to a residence or a predetermined contract form.

4. The vehicle control device according to claim 1, further comprising:
a storage unit that stores information,
wherein the other-vehicle recognition unit stores history information on a recognition result of another vehicle recognized in the past in the storage unit in association with a position of the subject vehicle, and
the specific-vehicle determination unit determines whether or not the other vehicle is another vehicle parked within a predetermined site on the basis of whether the other vehicle recognized in the past at the same position as the position of the subject vehicle is the same as the other vehicle near the subject vehicle recognized by the other-vehicle recognition unit by referring to the history information stored in the storage unit using the position of the subject vehicle in case that the other vehicle near the subject vehicle is recognized by the other-vehicle recognition unit.

5. The vehicle control device according to claim 2, wherein, in case that the specific-vehicle determination unit determines that the other vehicle is the specific vehicle parked at the predetermined site, the driving control unit suppresses an operation of deceleration control of the subject vehicle as compared with a case in which the other vehicle is determined not to be the other vehicle parked at the predetermined site.

6. A vehicle control method comprising:
recognizing, by a computer mounted in a vehicle, another vehicle near a subject vehicle;
determining, by the computer, whether or not the recognized other vehicle is another vehicle parked within a predetermined site;
controlling, by the computer, one or both of steering and acceleration/deceleration of the subject vehicle to cause the subject vehicle to travel regardless of an operation of an occupant of the subject vehicle; and
suppressing, by the computer, travel control of the subject vehicle with respect to start of the other vehicle in a case in which the other vehicle is determined to be the other vehicle parked at the predetermined site as compared with a case in which the other vehicle is determined not to be the other vehicle parked at the predetermined site.

7. A computer-readable non-transitory storage medium storing a program, the program causing a computer mounted in a vehicle to:
recognize another vehicle near a subject vehicle and determine whether or not the recognized other vehicle is another vehicle parked within a predetermined site;
control one or both of steering and acceleration/deceleration of the subject vehicle to cause the subject vehicle to travel regardless of an operation of an occupant of the subject vehicle; and
suppress travel control of the subject vehicle with respect to start of the other vehicle in a case in which the other vehicle is determined to be the other vehicle parked at the predetermined site as compared with a case in which the other vehicle is determined not to be the other vehicle parked at the predetermined site.
